(19) United States
(12) Patent Application Publication
(10) Pub. No.: US 2009/0232360 A1
(43) Pub. Date: Sep. 17, 2009

(54) PRE-PRINT DISTORTION

(76) Inventors: Stanley Michael Marcinkowski, Winthrop, MA (US); Michael Brown, Hertford (GB); Perry Shaun Rigler, East Grinstead (GB); John Arthur Hunt, Wadhurst (GB); Michael Scott Moren, Warwick, RI (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/047,439

(22) Filed: Mar. 13, 2008

(51) Int. Cl. G06K 9/00

(52) U.S. Cl. 382/112

(57) ABSTRACT

A thermoformed article carries an image. Using a first sheet carrying a grid image and a mold having at least two cavities, a forming carrying a grid distortion pattern for each cavity is made. An initial image is computed for each cavity based on the corresponding grid distortion pattern and a desired image. The initial images are applied to a second sheet. Using the second sheet and the mold, at least two articles are made, each article carrying a distorted image that is substantially similar to the desired image.

### FIELD OF THE INVENTION

This invention relates to thermoformed articles and methods of making the same. More particularly, this invention relates to making thermoformed articles carrying words and images, such as packaging for commercial products.

### BACKGROUND OF THE INVENTION

Processes for forming a three dimensional profile in a flat sheet of material are well known. Such processes are often used to produce plastic packaging, often called “blister” packaging, which can include stylized words and images to attract attention. The words and images may be created separate from and disposed in or on the packaging or created directly on packaging.

The technique of reverse printing lays down an image on the surface of a transparent layer, which, when viewed through the layer, shows a positive image. The image is reverse printed using a conventional printing technique, for example a UV flexographic or a gravure method using up to ten different colors. The image printed may be a plain design or one involving graphics for catching a viewer's attention. By the use of half tone techniques, near-photographic image quality can be achieved.

An image may be reverse printed on blister packaging before forming the three dimensional profile. Because forming stretches the image, some processes apply an initial image (i.e., distorted from the desired image) to the sheet so that, after forming, the distorted image (i.e., distorted from the initial image) resembles the desired image.

One example process prints a grid on a sample sheet, which is thermoformed to a desired shape. An initial image is computed based on the distortion of the grid caused by the thermoforming and a desired image. The initial image is reverse printed on to the surface of a transparent thermoplastic film. The film is laminated to a thermoplastic sheet, trapping the initial image between the film and the sheet, which helps prevent cracking in the image during thermoforming. The laminate is thermoformed to the desired shape with the desired image thereon.

In another example, a layer of expandable foam is covered on one side by a layer of Lycra® and on the other side by a layer of polyethylene to form a laminate. A pre-distortion version of desired image is applied to the outer Lycra® surface. Then, the laminate is thermoformed to a three dimensional profile having the desired image, during which the foam layer expands.

In another example, a rotating or moving electronic digital scanner is used to scan a distorted grid created by forming a flat grid in a mold. Numerical values representing the areas and degree to which a two dimensional image would have to be compressed are collected. A comparison between the numerical values and the scanned copy of the two-dimensional image determines the change needed to bring the two dimensional image and the numerical values into co-alignment at certain reference points. The change is applied to the two dimensional image to form an altered or compressed two-dimensional image. The altered image is printed onto a plastic stock, which is aligned with the mold and formed into a quasi three dimensional image.

### SUMMARY OF THE INVENTION

This invention relates to thermoformed articles and methods of making the same. More particularly, this invention relates to making deep draw thermoformed articles carrying images, such as packaging for commercial products. Initial images, different from a desired image, are printed onto a thermoformable material. The material is thermoformed, thereby distorting the initial images into desired images.

In one aspect, the invention features, in general, a method of making a thermoformed article carrying an image. Using a first sheet carrying a grid image and a mold having at least two cavities, a deep draw forming carrying a grid distortion pattern is made for each cavity. An initial image for each cavity is computed based on the corresponding grid distortion pattern and a desired image. The initial images are applied to a second sheet. Using the second sheet and the mold, at least two deep draw articles are made. Each article carries a distorted image that is substantially similar to the desired image.

Certain implementations of the invention may include one or more of the following features. An L/D ratio of the article is less than about 4:1. The L/D ratio is about 3:1. The L/D ratio is about 2:1. The initial images are applied by reverse printing. The initial images are applied by selectively applying patterns of ink in high strain areas to prevent image cracking. The initial images are applied by at least one of the following techniques: gravure printing, UV flexographic printing, lithographic printing, or offset printing. The first sheet is registered with the mold. The second sheet is registered with the mold. A coating is selectively applied on the applied initial images. The coating is a UV resistant varnish containing a slip agent. The sheets are preheated to about 130° F. The grid image includes relatively more lines disposed where the first sheet will experience relatively more deformation. An initial test image is made for each cavity. The initial test image is applied to a test sheet. A distorted test image is formed for each cavity. The computation of each initial image is based on a corresponding distorted test image.

“Image”, as used herein, is defined as words, images, pictures, characters, or graphics that could be found on consumer product packaging.

Other features and advantages of the invention will be apparent from the description of the preferred embodiments thereof and from the claims.

### BRIEF DESCRIPTION OF THE DRAWINGS

FIG. 1 is a perspective view of an embodiment of a formable sheet carrying a grid;

FIG. 2 is a perspective view of the sheet formed into two articles;

FIG. 3 is a perspective view of an embodiment of a formable sheet carrying two images;

FIG. 4 is a top partial view of a formable sheet carrying rows of ink dots;

FIG. 5 is a perspective view of the sheet formed into two articles each carrying an image; and

FIG. 6 is a top view of an embodiment if a formable sheet carrying a grid.

### DETAILED DESCRIPTION OF THE INVENTION

Multi-cavity thermoforming is a well known process for manufacturing high volumes of blister packaging components. But maintaining relatively tight dimensional tolerances over a large number of cavities (e.g. twelve or sixteen) is difficult and expensive. Some sources of cavity-to-cavity variation may be the temperature profile across a web of material spanning several cavities (e.g., material has a different temperature toward middle cavities than toward edge cavities) and cycle-to-cycle process (e.g., temperature, pressure) variation, using different thermoforming machines, and cavity dimensions.

Even when formed components have acceptable dimensions, printing the pre-formed material (i.e., pre-printing) so that the formed components carry desired images may present additional problems. The material in the same location on two or more formed components may have originated from different locations on pre-formed material, resulting in unacceptable cavity-to-cavity image distortion. Components having a so-called “deep draw” may develop unacceptable cracks in the images because of high strain.

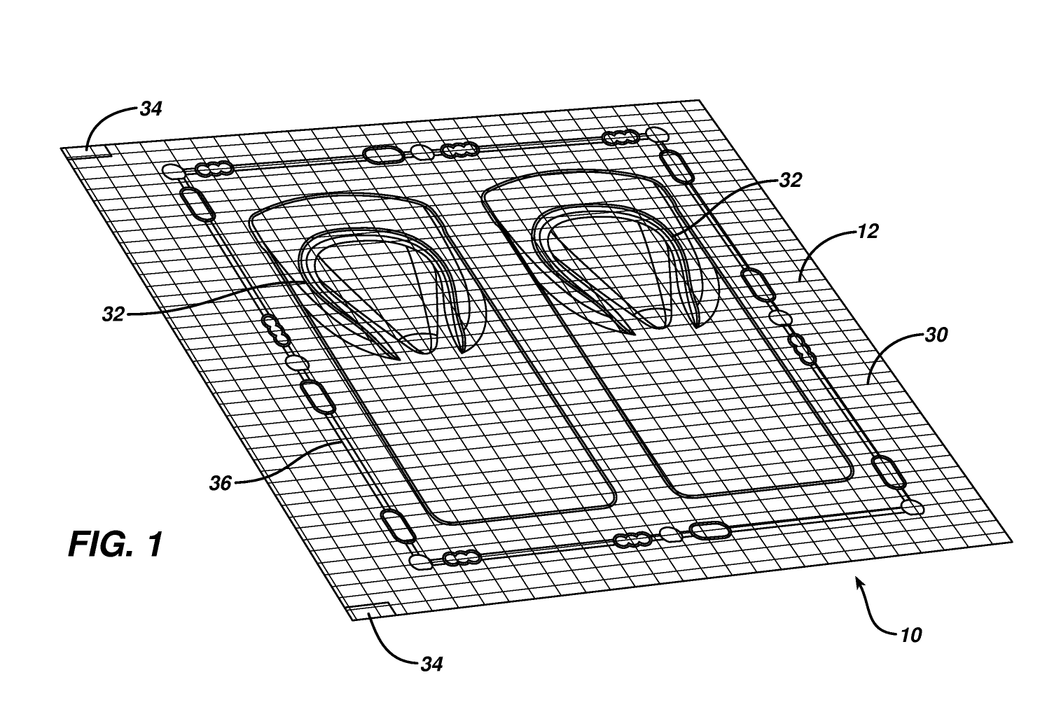

Referring to FIGS. 1-4, generally, an example of a method for making a high volume of blister packaging components bearing a substantially identical image is described. Sheet 10 carries a precisely printed grid pattern 12. A multi-cavity thermoforming process forms two blister packaging shells 14 in sheet 10, thereby distorting grid pattern 12 into unique distortion patterns 16 and 18 for each shell 14. Based on patterns 16 and 18 and a desired image, initial images 20 and 22 are computed and reverse printed on sheet 24. The same multi-cavity thermoforming process forms shells 26 with initial images 20 and 22 formed into distorted images 28, which are each substantially similar to the desired image. By calculating an initial image for each cavity of a particular thermoforming process, cavity-to-cavity image variation may be minimized.

Referring to FIG. 1, grid pattern 12 is printed on sheet 10. Preferably, in some examples, grid pattern 12 includes both a grid lines 30 and form lines 32. Grid lines 30 are spaced uniformly over sheet 10 while form lines 32 instead are disposed in areas that will undergo high strain during forming, which allows more accurate calculation of strain and deformation in those areas. In other examples, grid lines 30 or form lines 32 could be omitted. The grid is printed using the same printing process used to print the initial images as discussed below.

Grid pattern 12 includes registration marks 34. Initial images 20 and 22 must register with the thermoforming mold so that, after thermoforming, distorted images 28 will be substantially similar to the desired image. Sheet 10 must register in the same way so that the distortion of grid pattern 12 accurately represents how initial images 20 and 22 will be distorted. Otherwise, distorted images 28 will be different than the desired image. In some examples, the thermoforming machine index is linked to a set position on sheet 10 indicated by registration marks 34 to register sheet 10 with the thermoforming mold. In some examples, a photo electric cell may be used to read marks 34 and establish the link.

The precise placement of grid pattern 12 allows collection of accurate data over one or more extended manufacturing runs for each cavity of thermoforming tooling and, thus, more accurate process capabilities for each cavity. In turn, the data contributes to the calculation of initial images 20 and 22 that are more robust in the thermoforming process, thereby making the production of distorted images 28 more capable. Thus, it is important that processes and tooling be able to produce sufficient unit volumes and maintain acceptable process capability before calculating initial images for each cavity.

A preferred example of sheet 10 is a print grade PVC material, such as Klockner TH 280 having a thickness of at least about 0.015 inches. An alternative example of sheet 10 is a PET material, such as Klockner PETG Release TR having a thickness of about at least 0.015 inches. Both examples are available from Klockner Pentaplast of America in Rural Retreat, Virginia. In some examples, sheet 10 could be a portion of a web of material fed through printing and thermoforming process as is well known in the art. In other examples, sheets 10 could be individually fed as is also well known in the art.

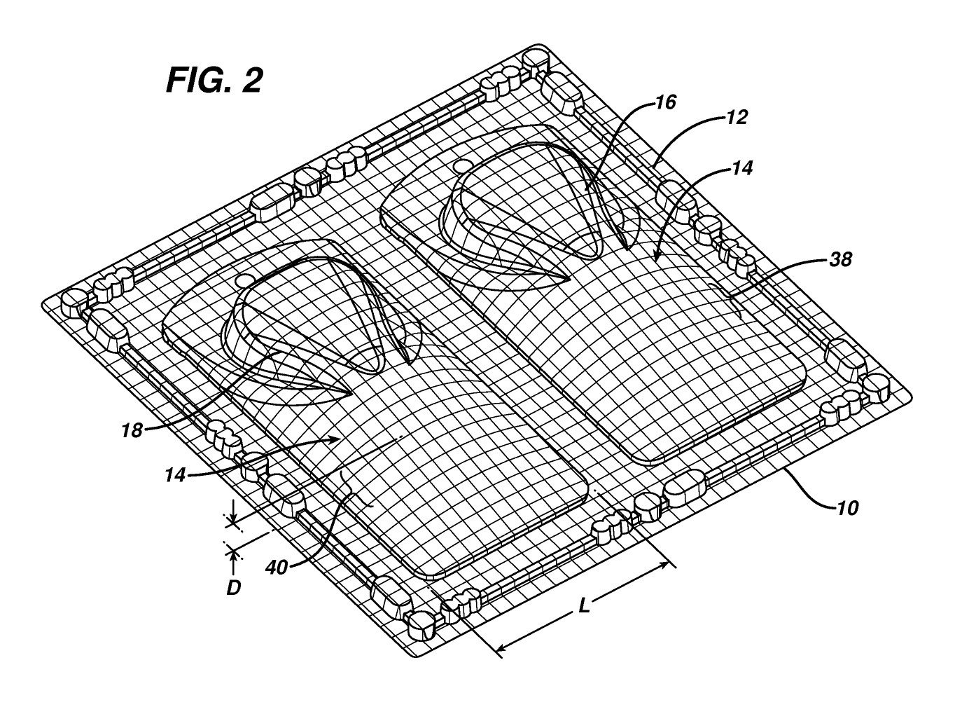

Referring to FIG. 2, shells 14 are formed in sheet 10 by a thermoforming process. In one example, sheet 10 is indexed through an auxiliary pre-heat station, gradually warming sheet 10 to about 130° F. Sheet 10 then enters a thermoforming oven system where it is heated to its glass transition state by top and bottom heating sections set between 600° and 980° F. Sheet 10 proceeds to the forming station where marks 34 are registered with the thermoforming mold. Shells 14 are formed when the mold plate and assist plate come together with vacuum on the mold side and pressure on the assist side force sheet 10 to con form with the mold. Sheet 10 is then indexed to a trim station which precisely cuts the material to a usable size. Other thermoforming process could be used to form shells 14.

Shells 14 are formed with a deep draw thermoforming process. Generally, the depth of draw in a thermoformed part may be expressed as a ratio of length to depth (L/D). The length is the minor length L of the part and the depth is the thickness D of the part in the area to carry the image. A “deep draw” thermoformed part, as used herein, has an L/D of less than about 4:1. In one example, in area 40, shell 14 has an L of about 3.75 inches and a D of about 1 inch, resulting in an L/D ratio of about 3.75:1. In another example, shell 14 could have a length of about 3.75 inches and a depth of about 1.625 inches for an L/D ratio of about 2.3:1.

Based on the relative displacement of grid lines 30 in area 38 from before and after thermoforming, initial image 20 may be calculated. In one example, grid lines 30 relates to a computerized grid generated by the Grid Warp software program, available from Artwork Systems Inc. of Bristol, Pa. Grid pattern 12 is scanned and the Grid Warp program is used to compare to the computerized grid with the scan. Each square of the computerized grid is mapped to mach the equivalent position on the scan. After mapping the entire computerized grid, a desired image is positioned and then modified using the “warp” function of the Grid Warp program, resulting in initial image 20. In a similar manner, initial image 22 is calculated based on the displacement of grid lines in area 40.

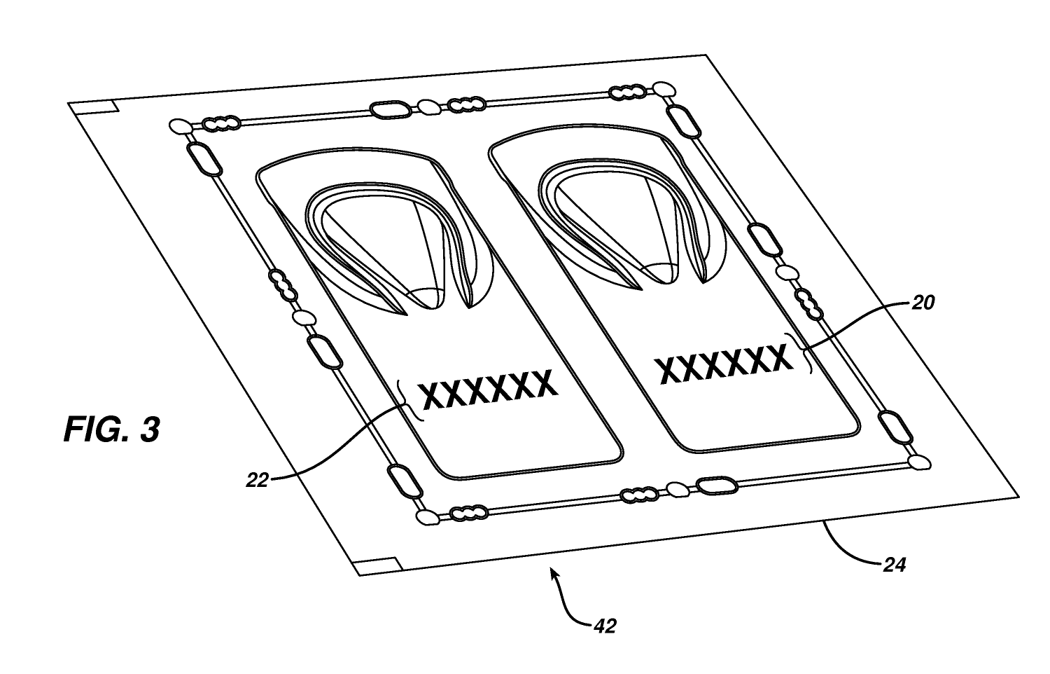

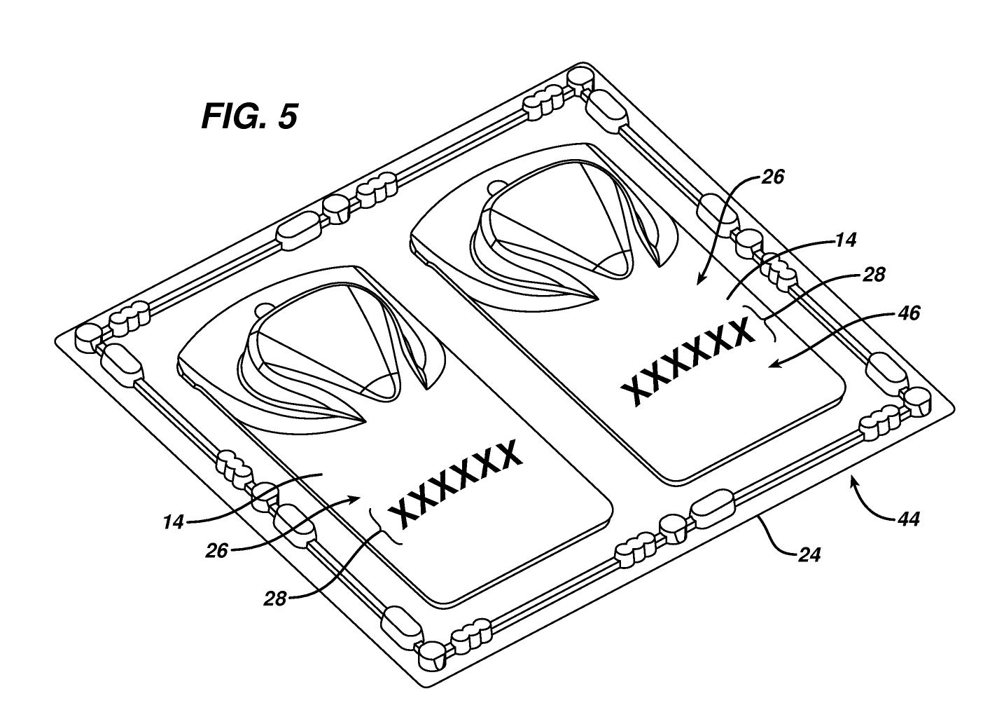

Referring to FIGS. 3-5, initial images 20 and 22 are reverse printed on to the lower surface 42 of sheet 24. Preferably, in some examples, initial images 20 and 22 are printed using a UV flexographic process. The cured ink film should have a high level of ink key to the sheet 24, be flexible to allow it to follow the contours of the thermoformed pack, and be elastic enough to enable the ink film to be stretched up to twice its initial printed surface area during the thermoforming process without displaying any cracking. In other examples, a gravure, or lithographic process may be used. In still other examples, an offset printing process could be used with an individual sheet feed.

In areas that experience high strain during forming, there is a likelihood that the ink will either crack or will break into lines perpendicular to the direction of stretch. Ink printing patterns may improve the formation of distorted images 28. In one example, solid colors are printed as a first screen 50 (i.e., a series of parallel lines dots rather than an overall solid covering) on a portion 58 of sheet 24 along lines 52 and a second screen 54 with the screen angle (i.e., the alignment of the dots) at a complementary angle to the first printed layer. An example of such complementary angles would be 90 and 105 degrees. When the portion 58 stretches in directions A and A′ the ink can stretch with the forming, without cracking, and because of the complementary dots the design does not appear to break into separate lines of dots.

Preferably, in some examples, the printing process applies a varnish (not shown) on initial images 20 and 22 as the final “color.” Alternatively, varnish could he applied by a dedicated process after printing. The varnish protects the images from being scratched and/or transferring to other surfaces. For example, shells 14 may be repeatedly formed in a web of material, which is fed onto a roll for subsequent packaging processes. The varnish prevents ink from transferring from an inner surface 44 of one shell 14 to an outer surface 46 of another shell 14. The varnish may also act as a slip agent for de-nesting shells 14 for assembly. One example is UVC 8785, available from Wikoff Color Corp. Fort Mill, S.C.

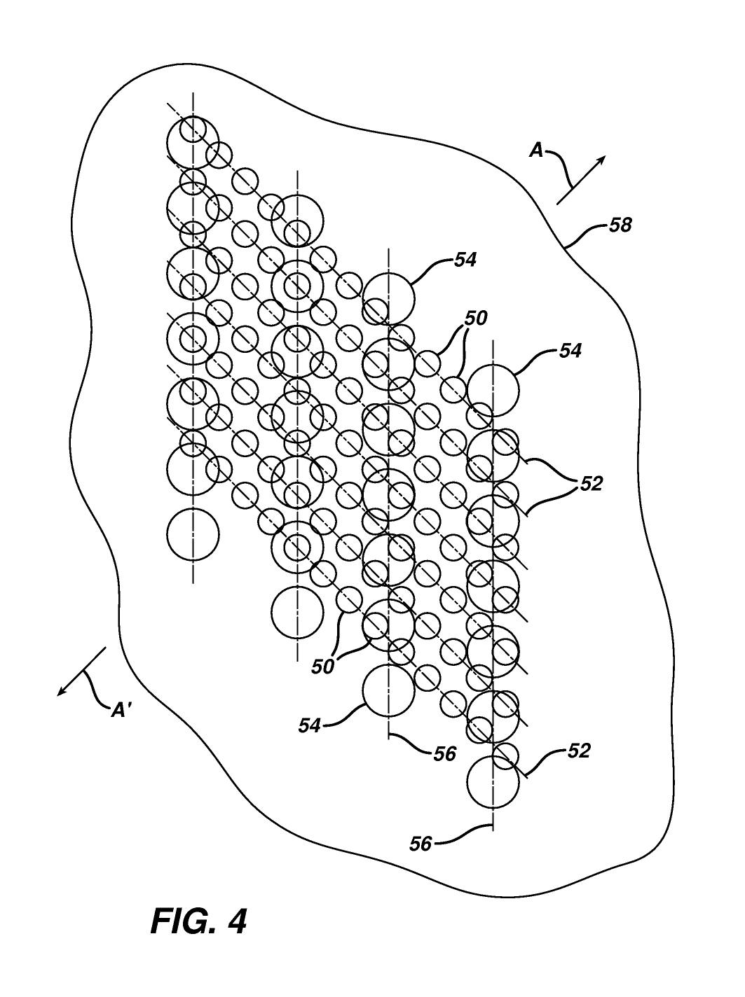

Referring to FIG. 4, the same thermoforming process as discussed above forms shells 26 in sheet 24. Each shell 26 bears a distorted image 28 that is substantially similar to the desired image. Some criteria for evaluating the similarity between distorted image 28 and the desired image may be, for example, color, clarity, image size and position, font size, and proper proportioning of the image.

In some examples, shells 26 remain attached to sheet 24 and stored until product is to be packaged. In some examples, the packaging processes could be in-line with the thermoforming process.

Referring to FIGS. 3 and 4, in some examples, images 20 and 22 are tuned in order to increase the overall capability of the printing and thermoforming processes. Tuning involves printing images 20 and 22 on sheet 24 in a single color and forming shells 14. Resulting single color images 28 are evaluated against the image specification and adjustments to images 20 and 22 are made, as necessary.

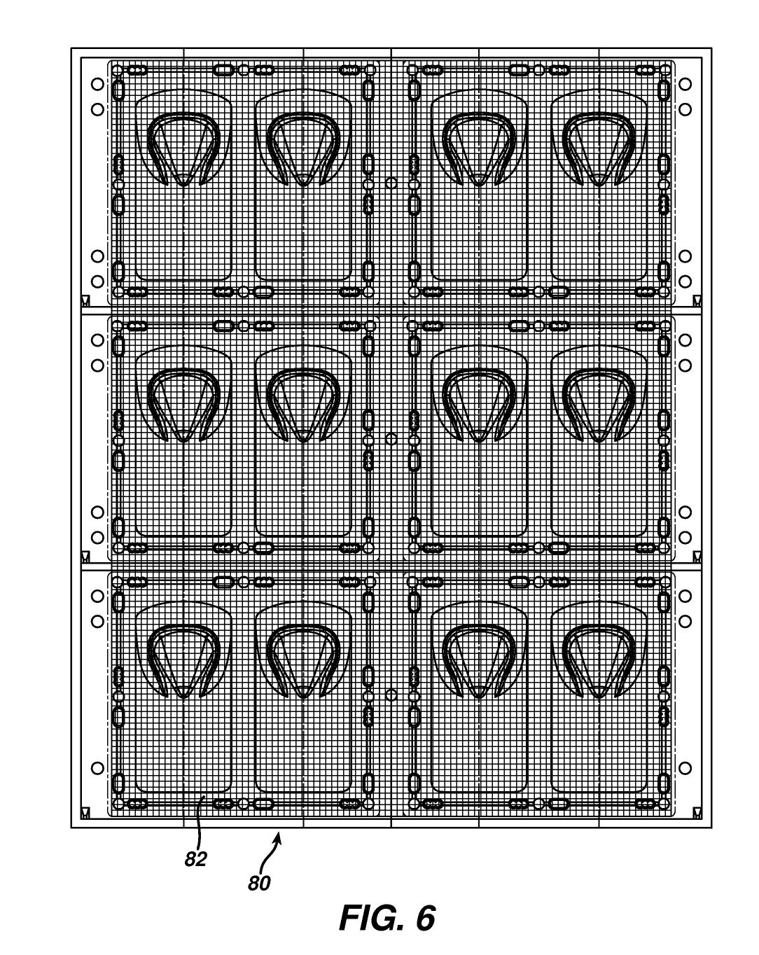

Referring to FIG. 6, the examples described above are not limited to two cavities. In some examples, sheet 80 may carry a grid pattern 82 for forming twelve cavities of shells. Other examples with other numbers of cavities are contemplated, limited only by the design of the thermoformed item and the thermoforming process itself.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of making a thermoformed article carrying an image, comprising:
using a first sheet carrying a grid image and a mold having at least two cavities, making a deep draw forming carrying a grid distortion pattern for each cavity;
computing an initial image for each cavity based on the corresponding grid distortion pattern and a desired image;
applying the initial images to a second sheet; and
using the second sheet and the mold, making at least two deep draw articles, each article carrying a distorted image that is substantially similar to the desired image.

2. The method of claim 1, wherein an L/D ratio of the article is less than about 4:1.

3. The method of claim 2, wherein the L/D ratio is about 3:1.

4. The method of claim 2, wherein the L/D ratio is about 2:1.

5. The method of claim 1, wherein applying the initial images comprises reverse printing the images.

6. The method of claim 1, wherein applying the initial images comprises selectively applying patterns of ink in high strain areas to prevent image cracking.

7. The method of claim 1, wherein applying the initial images comprises at least one of the following techniques: gravure printing, UV flexographic printing, lithographic printing, or offset printing.

8. The method of claim 1 further comprising registering first sheet with the mold.

9. The method of claim 1 further comprising registering the second sheet with the mold.

10. The method of claim 1 further comprising selectively applying a coating on the applied initial images.

11. The method of claim 10 wherein the coating is a UV resistant high slip varnish.

12. The method of claim 1 further comprising pre-heating the sheets to about 130° F.

13. The method of claim 1, wherein the grid image includes relatively more lines disposed where the first sheet will experience relatively more deformation.

14. The method of claim 1 further comprising making an initial test image for each cavity, applying the initial test image to a test sheet, forming a distorted test image for each cavity and basing the computation of each initial images on a corresponding distorted test image.

15. A method of making a thermoformed article carrying an image, comprising:
pre-heating a first sheet carrying a grid image including relatively more lines disposed where the first sheet will experience relatively more deformation;
registering the first sheet with a mold having at least two cavities.
making a deep draw forming carrying a grid distortion pattern for each cavity;
computing an initial image for each cavity based on the corresponding grid distortion pattern and a desired image;
making an initial test image for each cavity, applying the initial test image to a test sheet, forming a distorted test image for each cavity and basing the computation of each initial images on a corresponding distorted test image;
reverse UV flexographic printing the initial images to a second sheet comprising selectively applying patterns of ink in high strain areas to prevent image cracking;
selectively applying a UV varnish onto the initial images;
pre-heating the second sheet;
registering the second sheet with the mold; and
making at least two deep draw articles in the second sheet, each article carrying a distorted image that is substantially similar to the desired image.
